(19) United States
(12) Patent Application Publication
(10) Pub. No.: US 2004/0093951 A1
(43) Pub. Date: May 20, 2004

(54) Magnetoelastic pressure sensor

(76) Inventors: Jeffrey L. Viola, Berkley, MI (US); William T. Moore, Ypsilanti, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/300,102

(22) Filed: Nov. 20, 2002

(51) Int. Cl. G01L 9/10

(52) U.S. Cl. 73/728

(57) ABSTRACT

A magnetoelastic pressure sensor has an axially sensitive canister responsive to pressure induced tension. The sensor may have axially or circumferentially sensitive sensing structure. The pressure of a sense medium may be indirectly coupled to the interior of the chamber through an isolating member or medium. A reference structure may be provided for comparison with the sensing structure.

### BACKGROUND OF INVENTION

1. Field of the Invention

The present invention relates generally to a magnetoelastic pressure sensor and more particularly to a device for use in measuring the pressure of a fluid or gaseous medium in harsh temperature and vibration environments.

2. Description of the Prior Art

Devices for use in measuring pressure are well known. It is common for such devices to use a soft amorphous magnetic material, the permeability of which changes with stress. Such devices require an excitation voltage to induce in the material a magnetic field. A pressure to the material causes a change in the permeability of the material. The change in permeability is measured by detection circuitry. Consequently, such devices require circuitry for driving the material and circuitry detecting a change in permeability.

What is needed is a pressure-sensing device having component parts made from relatively common and inexpensive materials, having no moving parts, and which does not depend on measurement of deflection of a mechanical feature or member, such as commonly utilized in prior art pressure-sensing devices. The individual parts and the overall assembly of such a device are easy to manufacture using standard, simple processes. The simplicity, ease of manufacture, and use of inexpensive materials permits the device to be manufactured at a low cost.

### SUMMARY OF INVENTION

Generally speaking, the present invention is directed towards a pressure sensor that meets the foregoing needs. A pressure sensor according to one embodiment of the invention has an axially sensitive cavity responsive to pressure induced axial tension.

A pressure sensor according to another embodiment of the invention has an axially sensitive outer tube and an enveloped inner cavity to transmit pressure induced axial tension to the outer tube.

A pressure sensor according to yet another embodiment of the invention has multiple axially sensitive rods and an enveloped inner cavity to transmit pressure induced axial tension to the axial rods.

A pressure sensor according to still another embodiment of the invention has a circumferentially sensitive cavity; responsive to pressure induced hoop-directed tension, with sense coil windings shielded from sense medium.

A pressure sensor according to the invention may have a sense medium-isolating member and a stress-transmitting medium through which stresses are transmitted to the sensing structure.

The present invention may further include a reference structure which is unaffected by pressure induced tension.

Various objects and advantages of this invention will become apparent to those skilled in the art from the following detailed description of the preferred embodiment, when read in light of the accompanying drawings.

### BRIEF DESCRIPTION OF DRAWINGS

FIG. 1A is an environmental cross-sectional view in elevation of a pressure-sensing device according the present invention.

FIG. 1B is an environmental cross-sectional view in elevation of a pressure-sensing device similar to the device illustrated in FIG. 1A.

FIG. 2 is an environmental cross-sectional view in elevation of another pressure-sensing device according the present invention.

FIG. 3 is an environmental cross-sectional view in elevation of yet another pressure-sensing device according the present invention.

FIG. 4A is an environmental cross-sectional view in elevation of another pressure-sensing device according the present invention.

FIG. 4B is an environmental cross-sectional view in plan of the pressure-sensing device illustrated in FIG. 4A.

FIG. 5 is a diagrammatic representation of a pressure-sensing device according the present invention.

FIG. 6A is an environmental cross-sectional view in elevation of another pressure-sensing device according the present invention.

FIG. 6B is an environmental cross-sectional view in elevation of another pressure-sensing device according the present invention.

FIG. 7 is a diagrammatic representation of still another pressure-sensing device according the present invention.

### DETAILED DESCRIPTION

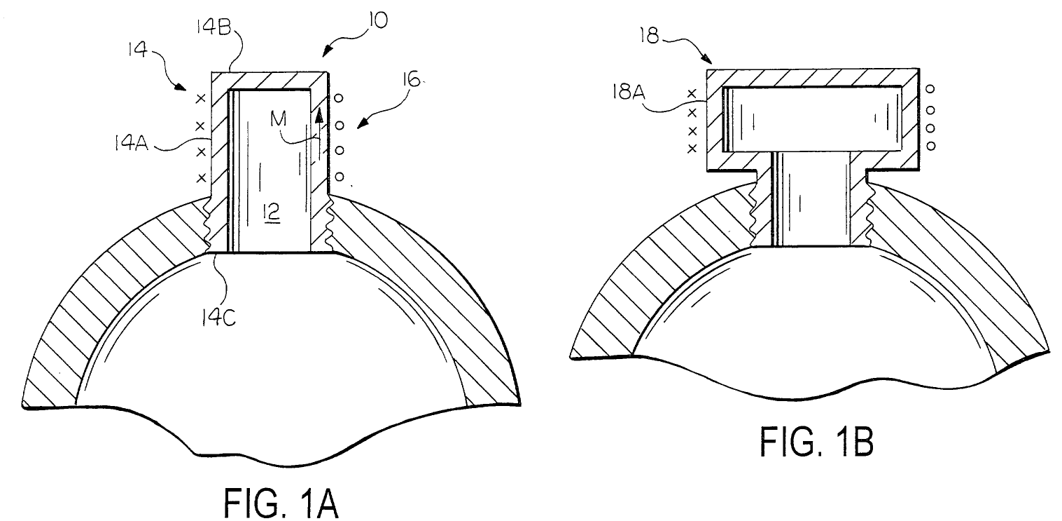

Referring now to the drawings, wherein like numerals designate like components throughout all of the several Figures, there is illustrated in FIG. 1A an embodiment of a magnetoelastic pressure-sensor 10 adapted for use in measuring the pressure of a fluid or gaseous medium in harsh temperature and vibration environments, such as, for example, in the combustion chamber of an internal combustion engine, although not limited to such. The sensor 10 is comprised of a cavity 12 that is adapted to be exposed to a medium, the pressure of which is to be measured. According-to the embodiment illustrated in FIG. 1A, the cavity 12, which is preferably generally cylindrical in shape, is configured in such a way that the pressure of the medium to be measured generates mechanical stresses in a sensing structure 14 of the sensor 10. The sensor 10 transduces the mechanical stresses.

The sensing structure 14 is made of a magnetostrictive or magnetoelastic material (hereafter referred generically to as magnetoelastic material). The sensing structure 14 may be the walls of a canister bounding the cavity 12 or a secondary structure, possibly a composite of structures, physically separate from the canister but mechanically coupled thereto. The configuration depends on the specific embodiment of the sensor.

According to the embodiment illustrated in FIG. 1A, a capped magnetoelastic cylindrical canister constitutes the sensing structure 14 itself. The sensing structure 14 has a cylindrical wall 14a and end caps 14b, 14c. The sensing structure 14 is exposed on its interior to the sense medium pressure through a hole 14d in one of its end caps 14c. The pressure generates axial tensile stresses (and incidental hoop or circumferential tensile stresses) in the sensing structure 14.

The sensing structure 14 is imparted with a predetermined induced remnant or retained magnetization or alternatively an actively applied, possibly time-varying magnetic field, indicated in the direction of arrow M in FIG. 1A. The direction of the imparted remnant magnetization M is a design attribute of the sensor 10 and may either be in the axial or circumferential direction of the sensing structure 14, depending on the specific embodiment of the sensor. The mechanical stresses generated in the sensing structure 14 have tensoral components in the direction of the imparted remnant magnetization M. The tensoral components of the stresses align with the imparted remnant magnetization M and interact with the imparted remnant magnetization M through the Villari phenomenon (a magnetoelastic effect) to cause a change in the magnetization of the sensing structure material. The change in the magnetization is directly proportional to the mechanical stresses in the sensing structure 14 and, hence, to the pressure of the sense medium. The change in the magnetization of the sensing structure material is measured using an electromagnetic search coil 16 wound in such a configuration as to be sensitive in either the corresponding axial or circumferential direction of the imparted remnant magnetization M in the sensing structure 14. In accordance with this embodiment of the invention, the electromagnetic search coil 16 is wound circumferentially around the exterior of the canister. The electromagnetic search coil 16 senses the changes in axial magnetization of the sensing structure 14 due to pressure induced stresses or changes in mechanical stresses generated in the sensing structure 14.

Another embodiment of the invention is illustrated in FIG. 1B. This embodiment is similar to that illustrated in FIG. 1A and described hereinabove but for the increased diameter portion 18A of the sensing structure 18.

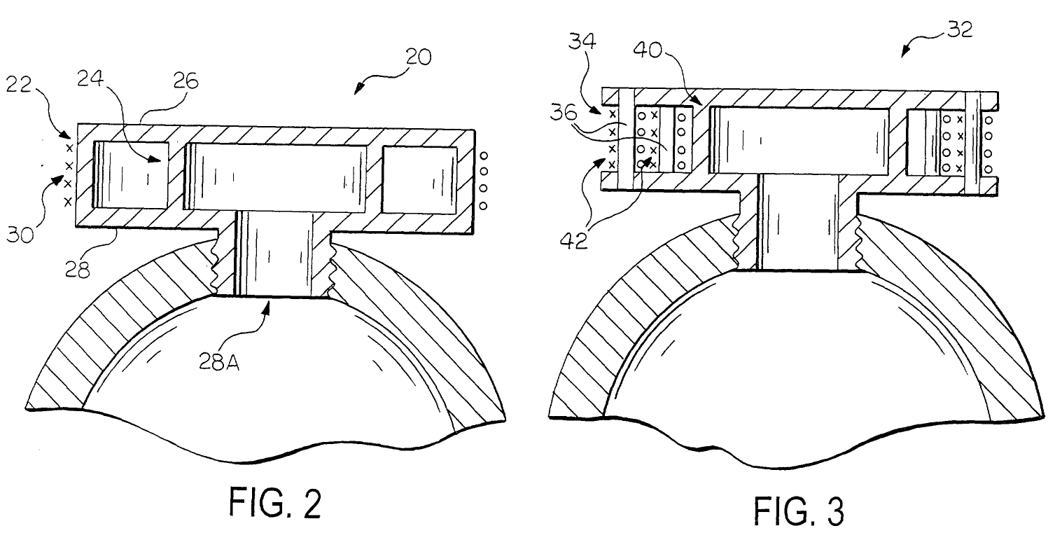

Another embodiment of the invention is illustrated in FIG. 2. The magnetoelastic pressure sensor 20 according to this embodiment of the invention comprises an axially sensitive magnetoelastic outer cylindrical tube 22 and an enveloped, stress-direction selective, inner cylindrical canister 24 for transmitting axial stress generated by the sense medium pressure to the outer cylindrical tube 22 and simultaneously suppressing the transmission of hoop stresses to the outer cylindrical tube 22. The outer cylindrical tube 22 and the inner cylindrical canister 24 are attached to each other through common end caps 26, 28, which transmit the axial tension between the inner cylindrical canister 24 and the outer cylindrical tube 22. The inner cylindrical canister 24 is exposed to the pressure of the sense medium through an opening 28a in one of the end caps 28. An electromagnetic search coil 30 wound circumferentially around the exterior of the outer cylindrical tube 22 senses the change in axial magnetization of the exterior of the outer cylindrical tube 22. This structural combination also serves to close the magnetic loop, thus eliminating the demagnetization factor as a potential source for the loss of remnant magnetization.

Yet another embodiment of the invention is illustrated in FIG. 3. The configuration of the sensor 32 according to this embodiment are similar to the embodiment described in the immediately preceding paragraph, except that the sensing structure 34 comprises multiple sensing magnetoelastic rods 36 arranged axially parallel to each other and forming a cylindrical corral. The cylindrical corral encircles the stress-direction selective, inner cylindrical canister 40. The magnetoelastic rods 36 replace the outer cylindrical tube 22 of the aforementioned embodiment. The embodiment shown reveals four sensing magnetoelastic rods 36. Individual sensing coils 42 are wound around each sensing magnetoelastic rod 36. The individual sensing coils 42 are connected electrically in series to form a composite-sensing coil. The series connections are made so as to constructively add the voltages induced in the individual sensing coils 42. This structural combination also serves to close the magnetic loop eliminating the demagnetization factor as a potential source for the loss of remnant magnetization.

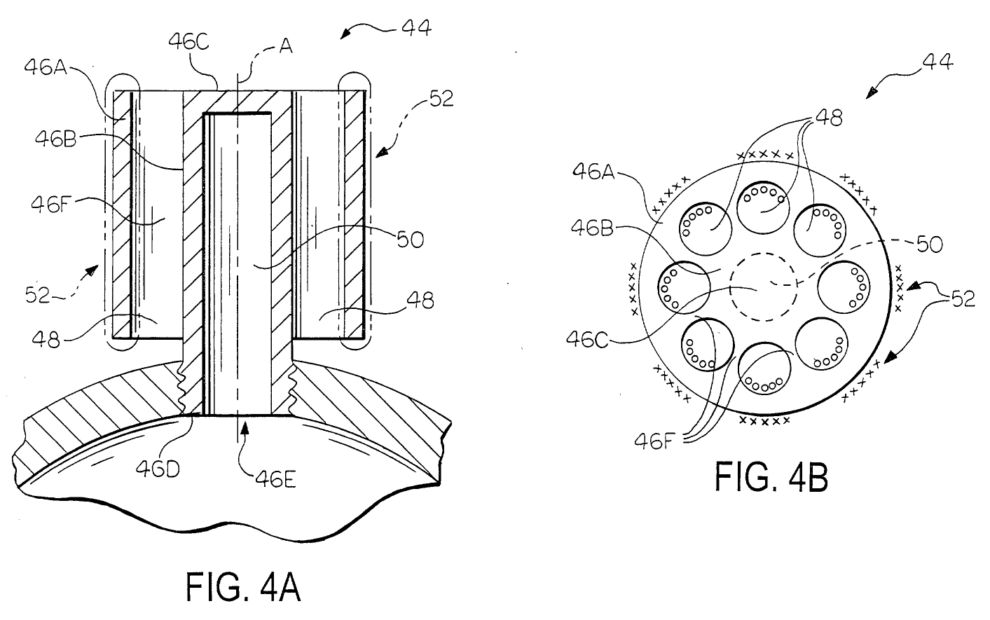

Still another embodiment of the invention is illustrated in FIGS. 4A and 4B. The pressure sensor 44 according to this embodiment of the invention is comprised of two concentric magnetoelastic cylindrical walls 46A, 46B and end caps 46C, 46D. The canister 46 is exposed on its interior to the sense medium through a hole 46E in one of the end caps 46D. The sensor 44 is similar in form to the embodiment described above with reference to FIG. 2. The sense medium pressure generates circumferential or hoop tensile stresses in a pressure-sensing cavity 50, as noted in the description above. However, the sensor 44 according to this embodiment of the invention responds to the circumferential stresses rather than the axial stresses, as is the done for the previously described embodiments. This embodiment differs structurally from that illustrated in FIG. 2 in that the concentric cylindrical walls 46A, 46B are rigidly attached to each other with spokes or spares 46F that run the axial length of the cylindrical walls 46A, 46B and parallel to the common axis A of the sensor 44. The inner cylindrical wall 46B isolates the sense medium from the outer cylindrical wall 46A. The spares 46F transmit the hoop stresses generated in the inner cylindrical wall 46B to the outer cylindrical wall 46A. Spaces bound by the cylindrical walls 46A, 46B and the spares 46F form holes 48 that run adjacent to the pressure-sensing cavity 50 and parallel to the pressure sensor axis A. The sensor structure may alternatively be fabricated from a single piece of metal stock, for example, by initially machining the part as a thick-walled cylinder and then drilling the holes length-wise through the thick walls parallel to the thick-walled cylinder axis. The holes 48 do not impinge into the pressure-sensing cavity 50 bounded by the inner cylindrical wall 46B. An electromagnetic coil 52 is wound around the outer cylindrical wall 46A where the windings of the coil 52 run parallel to the sensor axis A. The windings pass through the holes 50 between the two cylindrical walls 46A, 46B and then loop around the axial ends of the outer cylindrical wall 46A to run length-wise back along the outer surface of the outer cylindrical wall 46A. The windings, in effect, form a toroidal coil around the outer cylindrical wall 46B. The electromagnetic coil 52 thus wound senses the changes in the circumferential magnetization of the outer cylindrical wall 46A due to stress transmitted to the outer cylindrical wall 46A induced by a sense medium pressure. This circumferential structure and magnetization serve to close the magnetic loop eliminating the demagnetization factor as a potential source for the loss of remnant magnetization.

It should be fully appreciated by one of ordinary skill in the art that the sensors 10, 18, 20, 32, 44, and 58 according to the present invention utilize a magnetoelastic material that has a magnetically polarized magnetostrictive region or structural portion made of a polycrystalline material with a large enough coercivity to prevent loss of remnant magnetization and a large enough anisotropy to return magnetization of the region to its original state once stresses caused by an applied pressure are released.

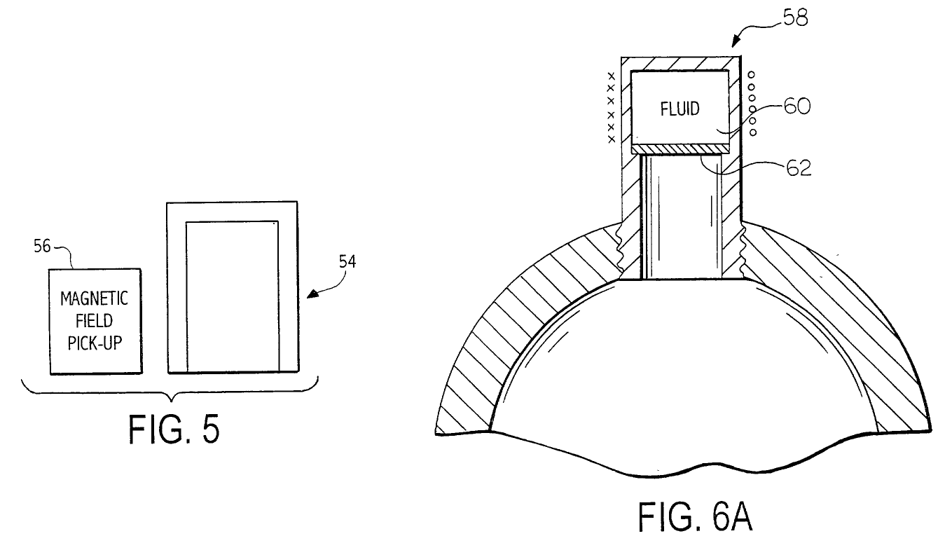

It should be further appreciated by one of ordinary skill in the art of the invention that the scope of the present invention is not limited coil windings illustrated in the drawing and described above. As diagrammatically represented in FIG. 5, any magnetic field pick-up 56 may be used for sensing changes in magnetization of the sensing structure 54.

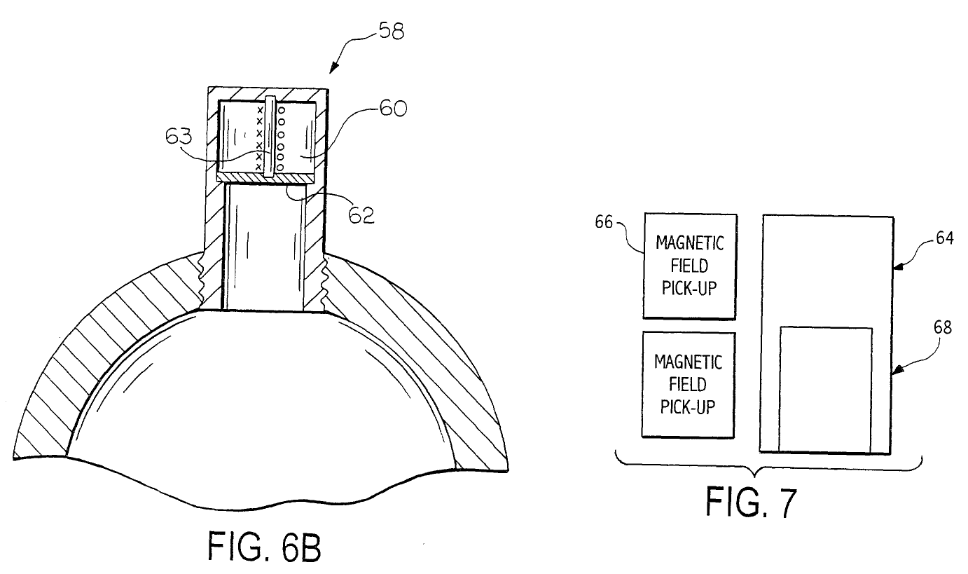

In certain applications, it may be desirable to restrict the sense medium from entering into the pressure-sensing chamber of the sensor. In these cases, the pressure of the sense medium may be indirectly coupled to the interior of the pressure-sensing cavity 60 through an isolating diaphragm 62, as illustrated in FIG. 6A. The pressure-sensing cavity 60, which is sealed by the diaphragm 62 from the sense medium, may be filled with an intermediate medium, either gaseous or liquid, which acts to transmit pneumatically or hydraulically the pressure from the sense medium through the diaphragm 62 to the interior surfaces of the pressure-sensing cavity 60 of the sensor 58 and all previously described embodiments of the invention 10, 18, 20, 32, and 44. Alternatively, an axially sensitive rod 63, as shown in FIG. 6B, responsive to pressure through compressive stresses may be provided between the diaphragm and an end cap. The sensor 58 according to this embodiment of the invention will not change or affect the volume of the sense medium.

In certain applications, it may also be desirable to provide a reference structure 64, as illustrated in FIG. 7, having an imparted predetermined remnant magnetization and an additional magnetic field pick-up 66 for sensing the magnetization of the reference structure 64. The magnetization of the reference structure 64 is substantially unaffected by changes in the sense medium pressure and thus provides a reference for comparison with the sensing structure 68, or for the cancellation of knocks or sounds sensed by the sensor.

While this invention has been described with respect to several preferred embodiments, various modifications and additions will become apparent to persons of ordinary skill in the art. All such variations, modifications, and variations are intended to be encompassed within the scope of this patent, which is limited only by the claims appended hereto.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A pressure-sensor adapted for use in measuring the pressure of a fluid or gaseous medium, the sensor comprising:
a cavity that is adapted to be exposed to a medium, the pressure of which is to be measured;
a sensing structure having an imparted remnant magnetization, the cavity being configured so that the pressure of the medium to be measured generates mechanical stresses in the sensing structure wherein the mechanical stresses have tensoral components that are in the direction of the imparted remnant magnetization to cause a change in the magnetization of the sensing structure that is directly proportional to the mechanical stresses in the sensing structure; and
a pick-up for sensing changes in the magnetization of the sensing structure due to changes in mechanical stresses in the sensing structure.

2. The sensor of claim 1, wherein the cavity is defined by the sensing structure, which comprises a cylindrical wall and end caps, the cavity having an interior that is adapted to be exposed to the medium pressure through a hole in one of the end caps.

3. The sensor of claim 2, wherein the pick-up is an electromagnetic search coil that is wound circumferentially around the cylindrical wall to sense changes in axial magnetization of the sensing structure.

4. The sensor of claim 2, wherein the cylindrical wall of the sensing structure has an increased diameter portion.

5. The sensor of claim 1, wherein the cavity is bounded by a cylindrical canister and the sensing structure includes an axially sensitive magnetoelastic outer cylindrical tube enveloping the canister, the outer cylindrical tube and the canister being attached to each other through end caps, the canister being exposed to the pressure of the sense medium through an opening in one of the end caps.

6. The sensor of claim 5, wherein the pick-up is an electromagnetic search coil wound circumferentially around the outer cylindrical tube to sense change in axial magnetization of the outer cylindrical tube.

7. The sensor of claim 1, wherein the cavity is bounded by a cylindrical canister and the sensing structure includes multiple sensing magnetoelastic rods arranged substantially axially parallel to each other and forming a cylindrical corral that encircles the cylindrical canister.

8. The sensor of claim 7, wherein the pick-up includes a sensing coil wound around each sensing magnetoelastic rod.

9. The sensor of claim 1, wherein the cavity is bounded by a canister and the canister and the sensing structure are defined by two concentric magnetoelastic cylindrical walls and end caps, the canister having an interior that is exposed to the sense medium through a hole in one of the end caps.

10. The sensor of claim 9, wherein the concentric magnetoelastic cylindrical walls are attached to each other with spares that run an axial length of the cylindrical walls and parallel to an axis of the sensor.

11. The sensor of claim 10, wherein an inner one of the cylindrical walls isolates the medium to be measured from an outer one of the cylindrical walls.

12. The sensor of claim 11, wherein the spares transmit the hoop stresses generated in the inner cylindrical wall to the outer cylindrical wall.

13. The sensor of claim 12, wherein the cylindrical walls and the spares cooperatively form length-wise holes that are parallel to the axis of the canister.

14. The sensor of claim 13, wherein the pick-up is an electromagnetic coil that is passed through each hole, looped around axial end caps of the outer cylindrical wall, and run length-wise along an outer surface of the outer cylindrical wall, wherein the electromagnetic coil senses changes in a circumferential magnetization of the outer cylindrical wall due to stress transmitted to the outer cylindrical wall.

15. A sensor of claim 1, wherein the cavity is bounded by a canister and the canister and the sensing structure are fabricated from a cylinder having one or more holes length-wise therethrough and parallel to an axis of the cylinder.

16. The sensor of claim 15, wherein the pick-up is an electromagnetic coil that is passed through each hole and run length-wise along an outer surface of the cylinder, and wherein the electromagnetic coil senses changes in a circumferential magnetization of the cylinder due to stress induced by the sense medium pressure.

17. The sensor of claim 1, wherein the pressure of the sense medium is indirectly coupled to the cavity through an isolating member.

18. The sensor of claim 17, wherein the cavity is filled with an intermediate medium, which acts to transmit the pressure from the sense medium through the isolating member to an interior surfaces of a canister bounding the cavity.

19. The sensor of claim 18, wherein the intermediate medium is gaseous or liquid.

20. A sensor of claim 1, wherein the sensing structure has imparted thereon a predetermined induced magnetization.

21. A sensor of claim 1, wherein the sensing structure has an actively applied magnetic field.

22. A sensor of claim 1, wherein the sensing structure has a time-varying magnetic field.

23. A sensor of claim 1, wherein the pick-up is an electromagnetic search coil.

24. The sensor of claim 1, further comprising a reference structure having an imparted remnant magnetization, and a pick-up for sensing the magnetization of the-reference structure, the magnetization of the reference structure being substantially unaffected by changes the sense medium pressure.

25. A sensor of claim 1, wherein the cavity is bounded by a magnetically conductive structure that provides a closed loop for the imparted remnant magnetization in the sensing structure, thus eliminating any demagnetization factor as a potential source for loss of the remnant magnetization.
